(19) United States
(12) Patent Application Publication
(10) Pub. No.: US 2009/0118045 A1
(43) Pub. Date: May 7, 2009

(54) Tensioner

(76) Inventors: Yahya Hodjat, Oxford, MI (US); Marc R. Cadarette, London (CA)

Correspondence Address: THE GATES CORPORATION, IP LAW DEPT. 10-A3, 1551 WEWATTA STREET, DENVER, CO, 80202, US

(21) Appl. No.: 11/982,090

(22) Filed: Nov. 1, 2007

(51) Int. Cl. F16H 7/12

(52) U.S. Cl. 474/135

(57) ABSTRACT

A tensioner comprising a cantilever spring having a first arm (13) and a second arm (14), the first arm and the second arm describing an included angle (α), a pulley (30) journalled to the first arm, a mounting portion (11), and a resilient damping member (20) disposed between the first arm and the second arm for damping an arm vibration.

### FIELD OF THE INVENTION

The invention relates to a tensioner, and more particularly to a tensioner comprising a cantilever spring and a resilient damping member engaged with the cantilever spring.

### BACKGROUND OF THE INVENTION

The main purpose of a belt tensioner is to prolong the life of an engine or accessory drive belt. The most typical use for such automatic belt tensioners is on front-end accessory drives in an automobile engine. This drive includes pulley sheaves for each accessory the belt is required to power, such as the air conditioner, water pump, fan and alternator. Each of these accessories requires varying amounts of power at various times during operation. These power variations create a slackening and tightening situation of each span of the belt. The belt tensioner is utilized to absorb these power variations.

Representative of the art is U.S. Pat. No. 6,224,028 to Tanaka which discloses a cantilever shaft assembly includes a steel pipe firmly secured at one end to a wall surface of a stationary support member, and a core shaft made from a synthetic resin and having a body portion removably fitted in the steel pipe and an end portion located outside the steel pipe. The end portion forms a free end of the cantilever shaft assembly and rotatably supports thereon a rotating member such as a driven sprocket. The core shaft and the steel pipe are locked and held together by a locking device such as a pin or a key. The cantilever shaft assembly is light in weight and can be easily repaired at a low cost when the end portion of the synthetic resin core shaft is damaged or worn out.

What is needed is a tensioner having a cantilever spring and a resilient damping member engaged with the cantilever spring. The present invention meets this need.

### SUMMARY OF THE INVENTION

The primary aspect of the invention is to provide a tensioner having a cantilever spring and a resilient damping member engaged with the cantilever spring.

Other aspects of the invention will be pointed out or made obvious by the following description of the invention and the accompanying drawings.

The invention comprises a tensioner comprising a cantilever spring having a first arm (13) and a second arm (14), the first arm and the second arm describing an included angle (α), a pulley (30) journalled to the first arm, a mounting portion (11), and a resilient damping member (20) disposed between the first arm and the second arm for damping an arm vibration.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a perspective view of the tensioner.

FIG. 2 is a perspective view of an alternate embodiment.

### DETAILED DESCRIPTION OF THE PREFERRED EMBODIMENT

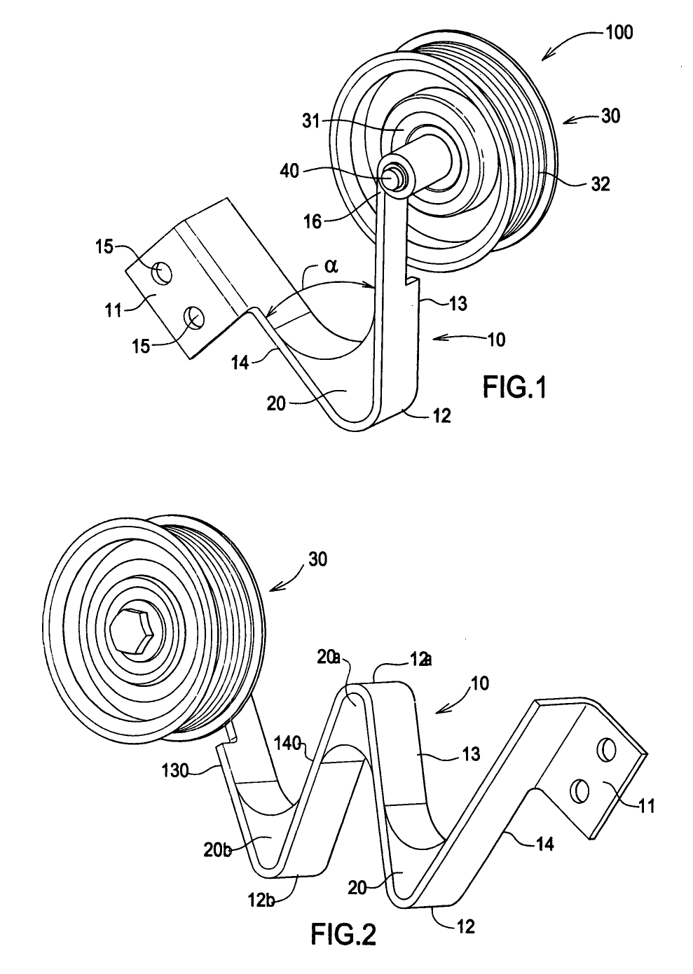

FIG. 1 is a perspective view of the tensioner. Tensioner 100 comprises a cantilever spring 10. Cantilever spring 10 has a mounting portion 11 disposed at one end for attaching the tensioner to a mounting surface, such as a vehicle engine (not shown). Mounting portion 11 may receive known fasteners such as bolts, screws or studs through holes 15.

Cantilever spring 10 is typically made from a flat metal strip bent in the form of a “V” as shown, or a “W” or other desired shapes. In the “V” configuration cantilever spring 10 comprises an elbow or bend 12. Bend 12 is disposed between arm 13 and arm 14. Arm 13 and arm 14 describe an included angle (α). Cantilever spring 10 may comprise any resilient material having a spring rate, including for example, metal or plastic.

A resilient damping member 20 is disposed in bend 12 between arm 13 and arm 14. Damping member 20 comprises known natural rubber or synthetic rubber or a combination of the two. For example, HNBR, EPDM, natural rubber, neoprene, VAMAC and SBR may be used with equal success. Damping member 20 may be sized to occupy all or a portion of the space bounded by arm 13 and arm 14. Damping member 20 is typically sized to properly damp vibrations while not unduly affecting the spring rate of cantilever spring 10.

Damping member 20 is adhered to the surface of arm 13 and arm 14 using suitable adhesives known in the art. Damping member 20 may be molded separately and then applied to the cantilever spring, or, it can be “molded in place” in bend 12 upon the cantilever spring in its described location. The damping member may also be attached by mechanical means such as fasteners or adhesives.

Pulley 30 is journalled to axle 40 at an end 16 of cantilever spring 10. Axle 40 is connected to arm 13. Pulley 30 rotates upon a bearing 31, which bearing 31 is connected to axle 40. Pulley 30 comprises a belt engaging surface 32 for engaging a multi-ribbed belt (not shown). Surface 32 may also be toothed, flat or v-shaped.

The inventive tensioner is used to apply a load to a belt in a belt drive system. The belt load is realized through compression of the cantilever spring. The magnitude of the applied belt load is a function of the spring rate of the cantilever spring. By way of example, the spring rate of cantilever spring 10 is in the range of approximately 0.25 Nm/degree up to 50 Nm/degree.

During operation of a belt drive system the belt will normally vibrate. The vibrations can be transmitted through the system unless they are damped. Damping member 20 damps vibrations transmitted from the belt to arm 13 and arm 14. In particular, damping member 20 damps relative movements between arm 13 and arm 14, and as may be characterized as periodic changes in angle (α).

FIG. 2 is a perspective view of an alternate embodiment. The alternate embodiment is the same as the embodiment described in FIG. 1 with the exception that instead of a single bend 12, this embodiment comprises more than one bend with bends 12a and 12b. Contained in each bend 12, 12a, 12b is a damping member 20, 20a, 20b. Arm 140 is connected to bend 12a and 12b. Arm 130 is connected to bend 12b. Pulley 30 is attached to arm 130. As is the case for the embodiment in FIG. 1, the spring rate of cantilever spring 10 is in the range of approximately 0.25 Nm/degree up to 50 Nm/degree.

Although a form of the invention has been described herein, it will be obvious to those skilled in the art that variations may be made in the construction and relation of parts and method without departing from the spirit and scope of the invention described herein.

We claim:

1. A tensioner comprising:
a cantilever spring having a first arm (13) and a second arm (14), the first arm and the second arm describing an included angle (α);
a pulley (30) journalled to the first arm;
a mounting portion (11); and
a resilient damping member (20) disposed between the first arm and the second arm for damping an arm vibration.

2. The tensioner as in claim 1, wherein the resilient damping member comprises natural rubber or synthetic rubber or a combination of the two.

3. The tensioner as in claim 1, wherein the resilient damping member is disposed between the mounting portion and the pulley.

4. The tensioner as in claim 1, wherein the pulley comprises a belt bearing surface having a multi-ribbed profile.

5. A tensioner comprising:
a cantilever spring having a first arm (13) and a second arm (14), the first arm and the second arm describing an included angle (α);
a pulley (30) journalled to the tensioner;
a mounting portion (11); and
a resilient damping member (20) disposed between the first arm and the second arm for damping an arm vibration.

6. The tensioner as in claim 5, wherein the resilient damping member comprises natural rubber or synthetic rubber or a combination of the two.

7. The tensioner as in claim 5, wherein the resilient damping member is disposed between the mounting portion and the pulley.

8. The tensioner as in claim 5, wherein the pulley comprises a belt bearing surface having a multi-ribbed profile.
